(19) United States
(12) Patent Application Publication
(10) Pub. No.: US 2002/0014972 A1
(43) Pub. Date: Feb. 7, 2002

(54) CONTROL STATION FOR CONTROL SYSTEM WITH AUTOMATIC DETECTION AND CONFIGURATION OF CONTROL ELEMENTS

(76) Inventors: MICHAEL T. DANIELSON, ROSELLE, IL (US); DAVID A. LECH, HOFFMAN ESTATES, IL (US); DAVID C. SCHIE, GLENDALE HEIGHTS, IL (US)

Correspondence Address: JOHN W HAYES, SONNENSCHEIN NATH & ROSENTHAL, 8000 SEARS TOWER, 233 SOUTH WACKER DR, CHICAGO, IL, 606066404

(21) Appl. No.: 09/026,517

(22) Filed: Feb. 20, 1998

(51) Int. Cl. G08B 5/00

(52) U.S. Cl. 340/815.4; 340/540

(57) ABSTRACT

A control station for a control system with automatic detection and configuration of control elements comprising an LCD display panel providing both input means for operator selection and output means for conveying information to the operator, means for displaying, in response to operator selection input, a plurality of preselected application title indicia representative of activities associated with particular locations, means for selecting, from among the plurality of preselected application title indicia, a particular application title indicium to provide a selected application title, means for displaying, in response to operator selection input, a plurality of preselected scene title indicia associated with the selected application, means for selecting, from among the plurality of preselected scene title indicia, a particular scene title indicium to provide a selected scene, means for displaying, in response to operator selection input, one or more circuit title indicia representative of circuits eligible to be associated with the selected scene, means for selecting an eligible circuit for association with the selected scene, and means for programming operating parameters of the selected circuit. A method for controlling lighting units in a distributed control lighting network is also described.

### FIELD OF THE INVENTION

This invention relates generally to electronic control systems and in particular to control systems having multiple control elements, and is more particularly directed toward a relatively low-cost control station for such a system that affords extended control and programming capability while retaining a relatively small installation footprint.

### BACKGROUND OF THE INVENTION

When electrical lighting systems were first introduced, there was little available in the way of control except for a conventional switch that would supply or remove power to the electrical lighting device. Of course, it was known to connect multiple electric lighting systems in parallel through the same switching device so that all of the lights could be turned on and off simultaneously.

Shortly after the introduction of electric lighting systems however, a need for varying the lighting level developed. Dimmable lights were commonly used in theaters and other large gathering places, and the dimming operation was effected through variable transformers to increase or decrease the voltage applied to the connected electric lighting units. Variable transformer dimming controls are bulky and expensive to manufacture. They also have a limited useful life because of the moving parts involved in such an apparatus.

Solid state dimming arrangements became popular after the introduction of the silicon controlled rectifier (SCR). An SCR is a three terminal device that will not begin conduction until sufficient gate current is introduced. The SCR made possible the control of the duty cycle of the AC voltage delivered to a load such as an electric light, thus controlling the brightness of the light. The original SCR dimmer circuits were somewhat inefficient, and would often tend to overheat.

New, more efficient dimmer circuits have been developed that effectively eliminate this problem. New dimmer circuits are also available in small packages for ease of installation. These new dimmer circuits often feature a rotatable control with a pushbutton switch, and are both easy to operate and install. The fact remains however, that for direct control over a particular load, a dimmer apparatus such as that just described must be electrically connected to the load intended to be controlled.

This need for a direct connection spurred the development of remotely controllable lighting control units that could be interconnected via a network and controlled by a central computing resource. Not only could a centralized computing resource handle the programming of multiple lighting control circuits or devices, but the central computer could also be configured to monitor or respond to other devices besides lighting. Smoke alarms, entry detection devices, temperature sensors, card reader/validation devices, and other electronic systems for which computer communication is easily devised were ultimately connected to such centralized computing systems. The centralized computing resource afforded a great deal of flexibility to building managers looking for lighting control in addition to the control and management of other necessary in-building systems. Consequently, many systems for large buildings using centralized computer resources successfully integrate not only lighting systems but fire alarm detection and response, entry access detection and verification, as well as control of various electronic signage, telephone communication with appropriate fire or security agencies, and other features required in a large facility.

The disadvantages of using a large computer system for controlling building lighting and other features are that central computing resources are expensive, and, if a centralized computer system is dedicated to building lighting and other control purposes, the computer cannot be used to support additional functions even though it would be idle much of the time. Operation of a centralized computer resource for controlling lighting and other subsystems requires one or more operators with special training in order to properly operate the complex user interface required for a large system. Electronic modules that perform electronic control functions, and that have the necessary circuitry to communicate with a remote computer, are expensive and difficult to install.

Centralized computer control of lighting, smoke detectors, security alarms, etc. is also a capability that many homeowners desire. The use of a dedicated centralized computer resource having complex programming screens and procedures, coupled with expensive control modules with computer communication capability, is beyond the reach of many homeowners on both technological and economic grounds. A need consequently arises for a simplified control terminal that can implement distributed control of a number of electronic control modules. Such a control terminal should be inexpensive, easy to install and operable by the average person with little training.

### SUMMARY OF THE INVENTION

These needs and others are satisfied by the control station in accordance with the present invention, which comprises an LCD display panel providing both input means for operator selection and output means for conveying information to the operator, means for displaying, in response to operator selection input, a plurality of preselected application title indicia representative of activities associated with particular locations, means for selecting, from among the plurality of preselected application title indicia, a particular application title indicium to provide a selected application title, means for displaying, in response to operator selection input, a plurality of preselected scene title indicia associated with the selected application, means for selecting, from among the plurality of preselected scene title indicia, a particular scene title indicium to provide a selected scene, means for displaying, in response to operator selection input, one or more circuit title indicia representative of circuits eligible to be associated with the selected scene, means for selecting an eligible circuit for association with the selected scene, and means for programming operating parameters of the selected circuit.

In one form of the invention, the input means associated with the LCD display panel comprises switch means collocated with displayed indicia. The output means associated with the LCD panel may comprise an array of individually controllable viewing elements.

In one aspect of the invention, the plurality of preselected application title indicia may comprise a plurality of plain language indicia or a plurality of icons. Likewise, the plurality of preselected scene title indicia may comprise a plurality of plain language indicia or a plurality of icons, as may the circuit title indicia.

The operating parameters of the selected circuit include brightness level of lighting units associated with the selected circuit.

In another aspect of the invention, a method is provided for controlling lighting units in a distributed control lighting network. The method comprises the steps of: providing an LCD display panel having both input means for operator selection and output means for conveying information to the operator, displaying, in response to operator selection input, a plurality of preselected application title indicia representative of activities associated with particular locations, selecting, from among the plurality of preselected application title indicia, a particular application title indicium to provide a selected application title, displaying, in response to operator selection input, a plurality of preselected scene title indicia associated with the selected application, selecting, from among the plurality of preselected scene title indicia, a particular scene title indicium to provide a selected scene, displaying, in response to operator selection input, one or more circuit title indicia representative of circuits eligible to be associated with the selected scene, selecting an eligible circuit for association with the selected scene, and programming operating parameters of the selected circuit.

Further objects, features, and advantages of the present invention will become apparent from the following description and drawings.

### BRIEF DESCRIPTION OF THE DRAWINGS

FIG. 1(a) illustrates a network of interconnected control system elements in which network operation is independent of the particular network medium selected;

FIG. 1(b) depicts, in block diagram form, the components of an LCD controller in accordance with the invention;

FIG. 2 illustrates the front panel of an LCD controller in accordance with the present invention;

FIG. 3(a) depicts a plurality of application titles displayed on the LCD controller;

FIG. 3(b) shows a plurality of preselected scene titles displayed in accordance with the present invention;

FIG. 3(c) illustrates a plurality of circuit titles displayed on the LCD controller in accordance with the present invention;

FIG. 4 depicts an LCD controller display in accordance with the present invention associated with the control of operating parameters of a particular circuit; and

FIGS. 5(a) and 5(b) illustrate display of particular scenes and circuits using icons in accordance with the present invention.

### DETAILED DESCRIPTION OF THE INVENTION

In accordance with the present invention, a control station for a control system with automatic detection and configuration of control system elements is described that provides distinct advantages when compared to alternatives available in the prior art.

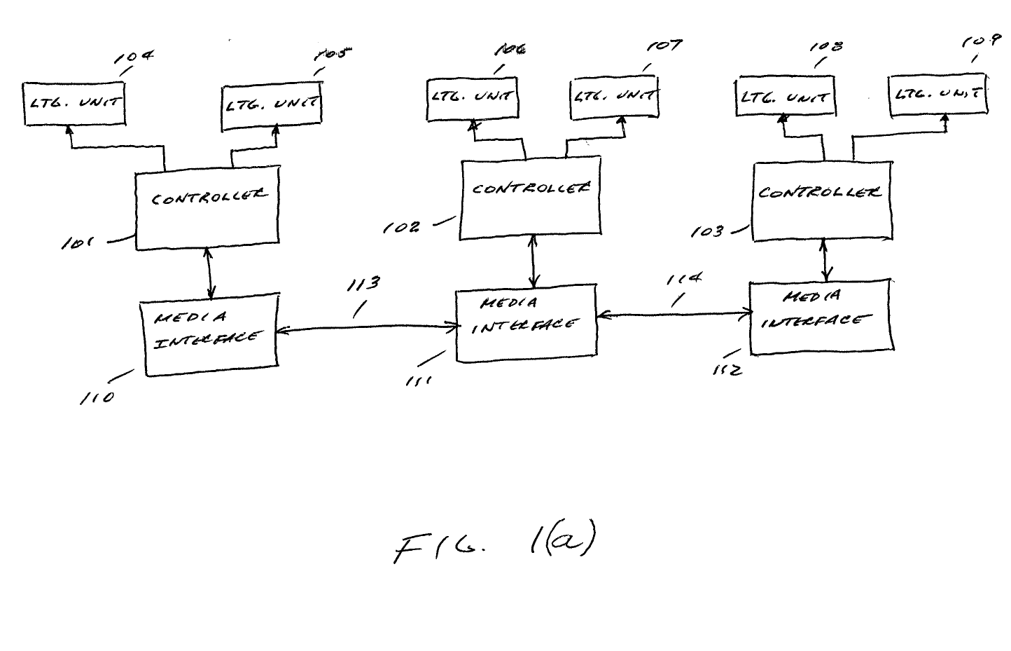

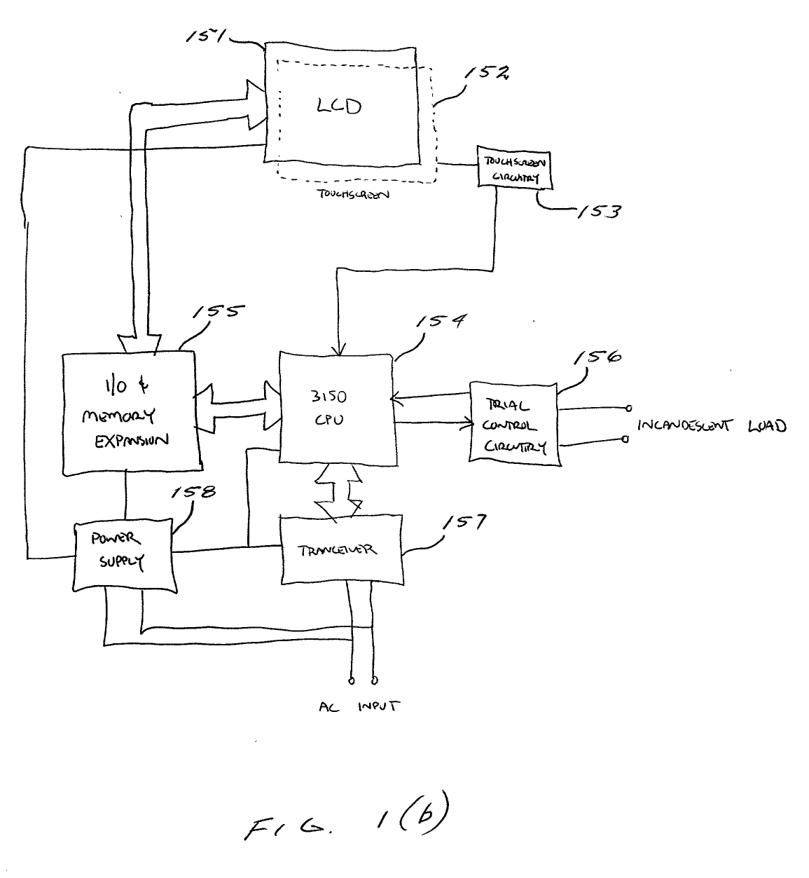

FIG. 1(a) illustrates a network of interconnected control system elements 101-103 in which network operation is independent of the particular network medium selected. In fact, the network shown can use multiple media types for interconnection of network elements.

As illustrated in FIG. 1(a), a particular control system element 101 can only exercise direct control over a lighting unit 104 to which there is a hard-wired electrical connection. As shown in FIG. 1(a), control system element 101 has a direct connection to lighting (Ltg.) units 104 and 105. The two lighting units 104, 105 are depicted as being on separate circuits, which is indeed practicable depending upon the circuit handling capability of the control element 101. It is more common, however, for the lighting units directly connected to each control element to be on the same electrical circuit.

Each of the controllers 101-103 is interconnected with a control network via media interfaces 110-112. Each interface 110-112 permits a particular type of interconnection of the control elements 101-103 with the control network. The types of specific interconnection may include, without limitation, RF (radio frequency), twisted pair, fiber optic, coaxial cable, or power line, among others. It is even possible for a given media interface 110 to support multiple media types, and thus ensure that all control elements are reachable over the network in scenarios involving multiple media connection. Of course, other known systems for multiple media interconnection may also be employed advantageously.

The control elements described allow control of lighting units widely separated from one another and on different electrical circuits, as long as their individual electrical control system elements are interconnected through the network.

The network interconnection and protocol, in addition to operating independently of the particular interconnection medium selected, requires some provision for arbitrating potential contention of the network so that a single master unit can configure the remaining control system elements. The preferred system protocol uses LonWorks (as described in more detail below) and LonWorks-supported network variables for communication between control elements on the network. Of course, other network interconnections that allow for resolution of a single master and support distributed control through updated global variables would also be acceptable in this application.

Because multiple communication media may be used in any control system installation, the particular network technology selected should be independent of the medium used for communication. One such flexible network technology is the LonWorks network supported by a family of Neuron Chips provided by Motorola, Inc. These Neuron Chips are sophisticated VLSI (very large scale integration) devices that make it possible to implement low-cost, local operating network applications.

Each Neuron Chip contains a LonWorks transceiver that is readily adaptable to any network medium through the use of an external interface. The Neuron ICs (integrated circuits) support direct-drive interconnection with a minimum of external components, and are easily adaptable, through external interface devices, to RF, power line, or other network media. Key features of the Neuron Chip and the LonWorks protocol that make this avenue attractive are the inclusion of a unique identification number in each Neuron Chip, establishment of a network protocol, and easy access to a set of network variables. Of course, other network protocols and chip sets in addition to the Neuron Chip and LonWorks mentioned herein would readily be adaptable to the network principles described.

Maximum utility in this distributed control environment can be achieved through the implementation of inexpensive controllers which display and readily communicate useful information to the user. These distributed controllers are also small in size so that their overall footprint is no larger than a conventional wall switchplate. In conveying information to the operator, the inventive controller element, as shown in FIG. 1(b), makes use of a liquid crystal display (LCD) 151 that conveys appropriate indicia of the particular function selected or operation being conducted.

The controller element includes a well-known microprocessor 154 and associated RAM (random access memory) for storage of both system-wide and local variables, and ROM (read-only memory) for operating program storage. In fact, the system includes expansion capability for additional I/O (input/output) and additional memory 155. As described above, the inventive controller also includes a network control portion that may make use of the LonWorks chips (or appropriate equivalents) described above, as well as a media interface device 157 that provides a hardware interface between the controller and the medium or media that support device interconnection over the network.

For the system illustrated, the hardware interface 157 is a transceiver that interfaces with the AC power line. In order to accommodate multiple media types, such as power line, RF, fiber optic, etc., the system may be configured into common media subnetworks, with an appropriate router (not shown) added to the system to direct messages to the proper subnetwork for each media type.

Preferably, the display area of the LCD controller is configured in a high-density dot-matrix format in order to provide maximum flexibility in displayed indicia and maximum resolution to enhance readability. The LCD viewing area may be of the known transmissive or reflective LCD display technologies, or well-known active matrix technology can be employed, even to the extent necessary to permit the use of color graphics on the LCD. The LCD area may also be backlighted, using an electroluminescent panel (or other suitable technique) for maximum viewability.

The visual indicia made possible through use of the LCD display may include either plain language displays or icons (pictures, in other words) that illustrate the function or operation currently in progress. Each of the control elements described not only allows the operator great flexibility in the entry and viewing of information relative to the control system, but also acts as an electronic control device for the particular devices to which it is directly interconnected.

One desirable feature of the system described herein is the capability of programming scenes. A scene is a particular configuration of lighting units and their associated operating power levels that can be programmed into the system memory through the use of the inventive system controller, and recalled with ease from any control element that is a part of the network.

Since the LCD-based controller also functions as a lighting control unit for the devices directly connected to it, the device's normal configuration is simply to display a dimmer level for the devices to which it is directly connected. FIG. 2 illustrates the front panel of an LCD controller in its normal configuration, generally depicted by the numeral 200. The LCD area includes an up arrow portion 210 for increasing the brightness of the attached lighting units, a down arrow 202 for dimming the lighting units, and an ON/OFF control button 203 for turning the attached lighting unit ON and OFF. The LCD controller 200 also includes a configuration pushbutton 205, used for selecting groups, for example, and a scene programming pushbutton 204.

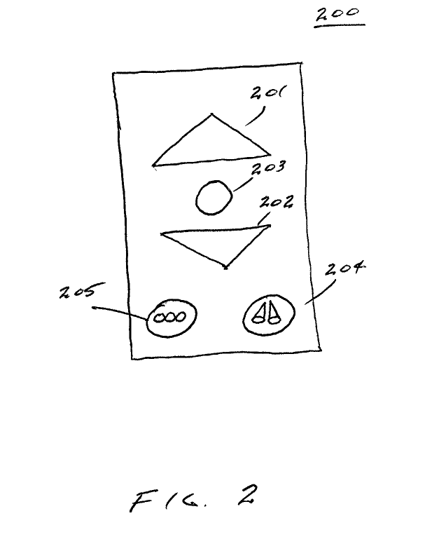

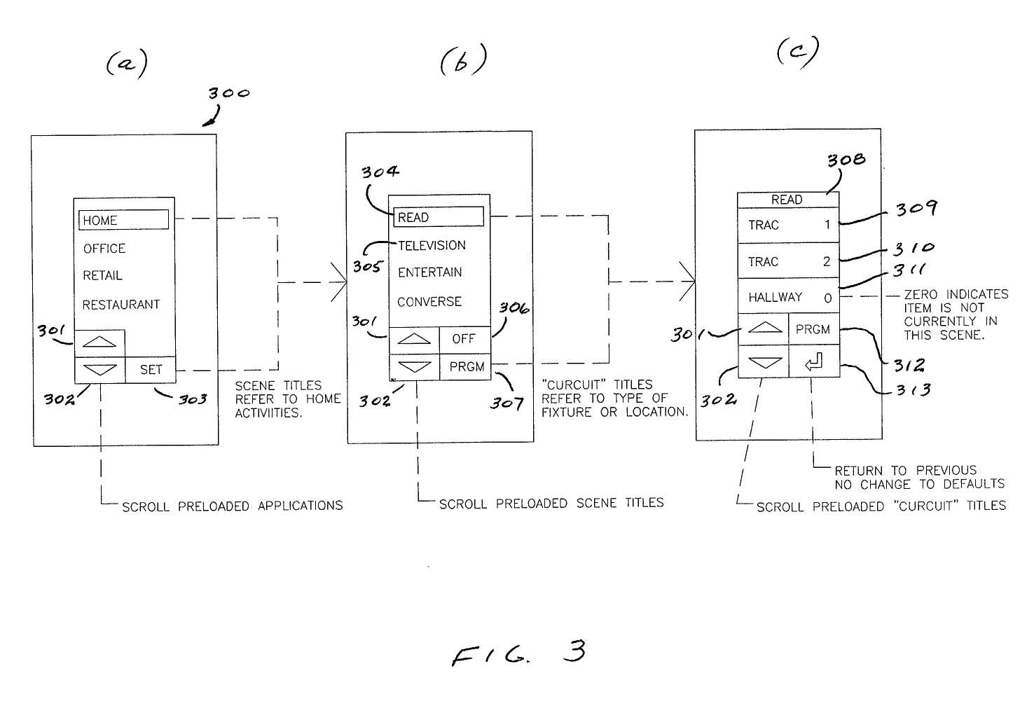

In order to invoke menu features available through the control unit, the scene programming pushbutton 204 on the front panel of the control unit is depressed until the display (300 in FIG. 3(a)) switches from displaying a dimmer level to displaying a collection of activity names (or activity icons), such as “HOME” and “OFFICE”, along with one or more scroll buttons 301, 302 and a SET button 303 that allows the user to access the scene titles associated with a particular activity name. The activities broadly describe the locations where particular preprogrammed scene names would be most applicable, as will be appreciated more fully in light of the following discussion.

Of course, it is to be understood that the control buttons referred to on the front panel 300 of the LCD unit are simply images displayed on the LCD display that coincide in location, in one embodiment, with the contacts of a switch matrix deposited using nearly transparent thin-film technology. Thus, there may be a physical switch associated with scroll buttons, icons, plain language IDs of particular activities or scenes and other push button controls, but the user cannot see this portion of the switching matrix, and may operate the controller by simply pressing the associated icon or plain language label. In the alternative, an analog resistive panel, well-known in the art for providing positional information, may be used in lieu of a switch matrix.

To configure a particular scene, the scroll controls 301, 302 on the LCD front panel 300 are operated to highlight a different plain language scene description or icon. FIG. 3(b) illustrates the plain language description display in which a particular scene name, such as “READ” 304 as illustrated in FIG. 3(b), is highlighted on the display. READ is an abbreviation for “Reading Lighting Levels,” and is intended to allow the user to program selected lighting units and associated lighting levels so that illumination in the area is appropriate for reading.

Depressing the down arrow 302 will cause the TELEVISION plain language scene description 305 to be highlighted, and additional pressing of the scroll down control 302 will highlight the remaining scene names in sequence. As mentioned above, for the convenience of the user a number of activity titles, such as HOME, OFFICE, etc., are preprogrammed into the LCD controller unit, as are scene names such as READ, TELEVISION, ENTERTAINMENT, etc.

To configure a particular scene, in one embodiment, the user may simply press the highlighted selection 304. In another embodiment of the invention, the user must select a particular scene for programming by highlighting the desired selection and depressing the program (PRGM) button 307. In the event that the user decides not to perform any scene programming functions, the OFF button 306 may be depressed to return to the previous screen 300 (FIG. 3(A)).

If the PRGM button 307 is depressed, the display will then change to reflect information relating to the lighting units in the current scene. In FIG. 3(c), one embodiment of the invention is depicted, and the scene title (READ) 308 is displayed at the top of the viewing area. Selection of the reading scene involves control of lighting units denominated as TRAC 1 (for track lighting unit number 1) 309, TRAC 2 (track lighting unit 2) 310, and HALLWAY (denoting a nearby hallway lighting circuit) 311. The index number (1 in TRAC 1 0 in HALLWAY, for example) reflect the system's ability to keep track of numerous lighting units of the same descriptive type (with respect to the 1 and 2 in the TRAC circuit names), and to indicate whether a particular circuit is part of the scene. The FIG. 3(c), the HALLWAY circuit name 311 is followed by the index number 0, to indicate that the HALLWAY circuit is not currently part of the READ scene.

The selection indicators (LED or light emitting diode indicators that are part of the front panel of all device controllers, but are not indicated in the drawing) of all devices in the system that support scene control will either be flashing to indicate that the particular unit is not yet a member of the selected scene, or be on continuously to indicate that the unit is already a member of the scene selected. Any device may join or leave the scene by simply toggling the selection button on the front panel of that particular controller device.

When a device is to join the scene, it's selection button is toggled until the selection indicator is ON steadily. When a device is to be removed from the scene, it's selection button is toggled until its selection indicator is flashing. Adjustments to the scene setting (in other words, the light level for dimmers) can only be made while the particular device is not a scene member, i.e., its selection indicator must be flashing in order for adjustments to be made.

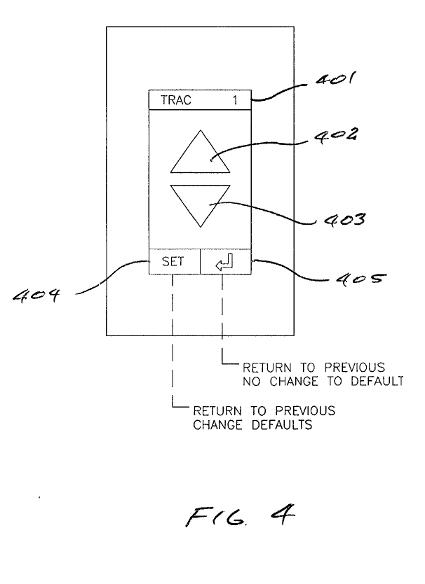

Selection of a particular lighting element to be adjusted is accomplished by using the scroll buttons 301, 302 to highlight the lighting unit where adjustment is required, then depressing the program (PRGM) button 312. The display will change as illustrated in FIG. 4 so that the name 401 of the particular lighting unit or circuit to be controlled, TRAC 1 in the example shown, is displayed at the top of the LCD panel, and UP and DOWN control buttons (402 and 403, respectively) are provided in a central location to vary the brightness setting. The SET button 404 is then depressed and the display returns to displaying the controllable elements or circuits for the scene selected, as depicted in FIG. 3(c). In the event that the operator wishes to terminate the programming function and return to the previous screen, the operator simply depressed the RETURN button 313, identified by a right-angle arrow in FIG. 4.

To recall a particular scene, as illustrated in FIG. 3(b), if the TELEVISION setting (lighting levels appropriate for television viewing) is desired for the lighting fixtures in a particular area, the scroll buttons 301, 302 are operated to highlight the TELEVISION plain language label 305. When the highlighted plain language label for the particular scene desired is depressed, that scene will be selected and the lighting units will be adjusted to the programmed values for that scene.

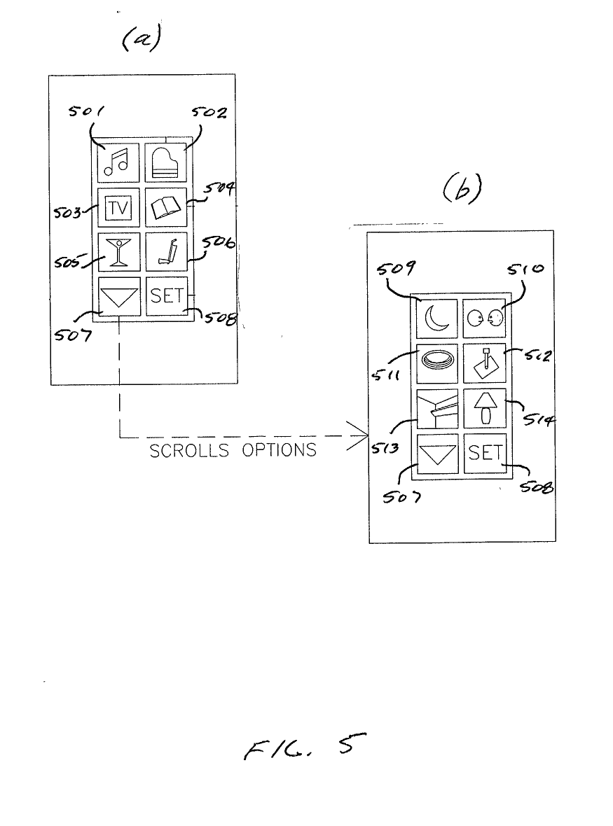

FIG. 5(a) illustrates a graphical user interface made possible through the use of icons or pictures rather than the plain language labels illustrated in previously described drawing figures. After the operator depressed the scene programming pushbutton (204 in FIG. 2), the LCD display screen conveys the particular scenes available through icons rather than descriptive names.

The musical notes symbol 501 identifies a scene associated with the lighting fixtures and associated lighting levels programmed for listening to music. The piano icon 502 identifies the piano lighting scene. The TV icon 503 identifies the television viewing scene, while the book icon 509 denotes the reading scene. The cocktail glass icon 505 is associated with the entertainment scene, and the vacuum cleaner icon 506 identifies the lighting scene programmed for cleaning.

The crescent moon icon 509 in FIG. 5(b) is associated with an evening lighting scene, while the faces 510 indicate a conversation scene. The icon interface can also identify particular circuits that can be added or programmed in a given scene. Icon 511 identifies a recessed ceiling lighting circuit, icon 512 identifies sconce lighting (wall-mounted fixtures), icon 513 indicates cove lighting, and icon 514 indicates a table lamp or lamps.

It should be noted that the system described has an inherent flexibility that permits control of more than just lighting systems. For example, the system could be used to initiate events in response to a set of input events. Water level control applications, in which pumps and valves must be activated in response to input signals, is an example of a more complex control application. The system should also not be construed as limited to the control of devices operating at AC line voltage. Low voltage AC and DC systems, as well as high-voltage AC (220 volts or more) are also contemplated as within the scope of the capabilities described.

There has been described herein a control station for a control system that accommodates automatic detection and configuration of control system elements that is relatively free from the shortcomings of the prior art. It will be apparent to those skilled in the art that modifications may be made without departing from the spirit and scope of the invention. Accordingly, it is not intended that the invention be limited except as may be necessary in view of the appended claims.

What is claimed is:

1. A control station for a lighting control system comprising:
an LCD display panel providing both input means for operator selection and output means for conveying information to the operator;
means for displaying, in response to operator selection input, a plurality of preselected application title indicia representative of activities associated with particular locations;
means for selecting, from among the plurality of preselected application title indicia, a particular application title indicium to provide a selected application title;
means for displaying, in response to operator selection input, a plurality of preselected scene title indicia associated with the selected application;
means for selecting, from among the plurality of preselected scene title indicia, a particular scene title indicium to provide a selected scene;
means for displaying, in response to operator selection input, one or more circuit title indicia representative of circuits eligible to be associated with the selected scene;
means for selecting an eligible circuit for association with the selected scene; and
means for programming operating parameters of the selected circuit.

2. The control station of claim 1, wherein the input means associated with the LCD display panel comprises switch means collocated with displayed indicia.

3. The control station of claim 1, wherein the output means associated with the LCD panel comprises an array of individually controllable viewing elements.

4. The control station of claim 1, wherein the plurality of preselected application title indicia comprises a plurality of plain language indicia.

5. The control station of claim 1, wherein the plurality of preselected application title indicia comprises a plurality of icons.

6. The control station of claim 1, wherein the plurality of preselected scene title indicia comprises a plurality of plain language indicia.

7. The control station of claim 1, wherein the plurality of preselected scene title indicia comprises a plurality of icons.

8. The control station of claim 1, wherein said one or more circuit title indicia comprises one or more plain language indicia.

9. The control station of claim 1, wherein said one or more circuit title indicia comprises one or more icons.

10. The control station of claim 1, wherein the operating parameters of the selected circuit include brightness level of lighting units associated with the selected circuit.

11. A method for controlling lighting units in a distributed control lighting network, the method comprising the steps of:
(a) providing an LCD display panel having both input means for operator selection and output means for conveying information to the operator;
(b) displaying, in response to operator selection input, a plurality of preselected application title indicia representative of activities associated with particular locations;
(c) selecting, from among the plurality of preselected application title indicia, a particular application title indicium to provide a selected application title;
(d) displaying, in response to operator selection input, a plurality of preselected scene title indicia associated with the selected application;
(e) selecting, from among the plurality of preselected scene title indicia, a particular scene title indicium to provide a selected scene;
(f) displaying, in response to operator selection input, one or more circuit title indicia representative of circuits eligible to be associated with the selected scene;
(g) selecting an eligible circuit for association with the selected scene; and
(h) programming operating parameters of the selected circuit.
